(19) United States
(12) Patent Application Publication
(10) Pub. No.: US 2026/0257251 A1
(43) Pub. Date: Sep. 3, 2026

(54) MOLDED RUBBER FLOOR MAT WASHER

(71) Applicants: Jon P. Kolquist, Royal Palm Beach, FL (US); Derek Kolquist, Royal Palm Beach, FL (US)

(72) Inventors: Jon P. Kolquist, Royal Palm Beach, FL (US); Derek Kolquist, Royal Palm Beach, FL (US)

(21) Appl. No.: 19/655,366

(22) Filed: Apr. 22, 2026

Related U.S. Application Data
(63) Continuation-in-part of application No. 18/909,643, filed on Oct. 8, 2024.
Application No. 18/909,643 is a continuation-in-part of application No. 17/897,868, filed on Aug. 29, 2022, now abandoned.
(60) Provisional application No. 63/240,518, filed on Sep. 3, 2021.

(51) Int. Cl. B08B 3/02; F26B 3/04

(52) U.S. Cl. CPC B08B 3/024; F26B 3/04

(57) ABSTRACT

A machine for cleaning vehicle rubber floor mats includes a housing with an interior washing chamber having an arrangement of rotating water nozzles that direct a pressurized spray of water onto the top side of the rubber floor mat that is held in opposing relation to the water nozzles. An electric motor operates a water pump to direct pressurized waterflow to the water nozzles at a pressure of between 2,000 psi and 3,500 psi. At the end of a washing cycle, the electric motor and pump are disabled and an air blower is activated to direct a flow of air onto the rubber floor mat at a rate of approximately 75 CFM during a drying cycle. A drain on the floor of the washing chamber directs the dirty water out of the housing of the machine which may be directed to a collection reservoir or the surrounding environment.

### BACKGROUND OF THE INVENTION

This non-provisional patent application is a Continuation-in-Part (CIP) of non-provisional patent application serial no. 18/909,643 filed on October 8, 2024, which is a CIP of non-provisional patent application serial no. 17/897,868 filed on August 29, 2022, which is based on provisional patent application serial no. 63/240,518 filed on September 3, 2021.

### FIELD OF THE INVENTION

The present invention is directed to a machine for cleaning floor mats found in vehicles and, more particularly, to a machine for washing vehicle floor mats that are made entirely of rubber.

### DESCRIPTION OF THE RELATED ART

Most vehicles use floor mats to protect the carpeted floors from wear and exposure to dirt, water, and other materials that may stain the carpet in the vehicle. These protective floor mats may be made of a combination of a rubber bottom and a carpet material on the top side that may match the color of the carpet in the vehicle. Carpeted or fabric top vehicle floor mats are usually cleaned by a vacuum process, either with a handheld vacuum nozzle, or a machine that allows the vehicle floor mat to be pulled through an arrangement of rollers and brushes while simultaneously vacuuming the carpeted or fabric top surface of the floor mat. Carpeted or fabric vehicle floor mats are usually flat and therefor are able to be fed through this type of machine having rollers and a rotating brush. In the event the carpeted or fabric floor mats become stained, they can be washed with a brush and carpet cleaner or other detergent.

Vehicle floor mats that are formed entirely of a rubber material are becoming increasingly popular. This is because they are generally easier to maintain clean, simply by washing with water with no need for cleaning chemicals and detergents. Many all-rubber floor mats are custom formed for particular vehicle models and have raised edges so that they contain water and other liquids, such as from rain or snow coming off of vehicle occupants’ shoes. The configuration of these custom molded all-rubber floor mats makes it difficult, if not impossible, to feed them through a machine having rollers and brushes. Moreover, there is really no need to brush all-rubber floor mats, as they are better cleaned by spraying pressurized water directly on the exposed surfaces to remove dirt, sand and other debris. The process for cleaning rubber floor mats with a high-pressure (i.e., 1,800 psi – 3,600 psi) hose, and possibly also with the use of a stream of water from a nozzle on a handheld brush, is not always practical, particularly at a self-service carwash. Much like the automated vehicle floor mat vacuum machines used for floor mats having a carpeted or fabric surface, there is a need for an automated machine for washing all-rubber vehicle floor mats.

### SUMMARY OF THE INVENTION

The present invention provides a machine that is structured for automated washing of vehicle floor mats that are made entirely of rubber. The floor mat washing machine includes an outer housing, with a front door that may hinge open at the bottom or along one side. The inside of the door is adapted to hold a rubber floor mat in place, such as with the use of clips, an open wire frame basket, or other structures and mechanisms, so that the top surface of the floor mat faces away from the inside door surface and towards the interior washing chamber of the machine. Within the interior washing chamber, the machine includes a rotating high-pressure sprayer assembly with at least one, and preferably multiple water nozzles fitted to distal end of arms extending from a central hub. The rotating high-pressure sprayer assembly is connected to a water pump driven by an electric motor. In a preferred embodiment, the water pump is between 5 hp (horsepower) and 9 hp and is capable of pumping water to the nozzles and out from the nozzles at a psi of between 2,000 psi and 3,500 psi. The water pump is connected to a water supply, such as a municipal water system, a water holding tank or other water containing reservoir. During operation, the water pump delivers a pressurized flow of water from the water supply to the water nozzles on the rotating high-pressure sprayer assembly. The arms and water nozzles are specifically arranged, angled and structured to spin about a central axis as a result of the thrust of the pressurized water exiting the nozzles at a pressure of between 2,000 psi to 3,500 psi. Thus, during operation, the high-pressure sprayer assembly spins while directing a pressurized spray of water from the multiple nozzles onto the exposed top surface of the rubber floor mat that is held on the inside surface of the closed door of the machine. The interior washing chamber of the machine further includes an arrangement of blower tubes connected to air blowers that automatically turn on after completion of the washing process, at which time the pressurized waterflow from the pump to the water nozzles stops. The blower tubes direct a forced flow of air from one side of the interior washing chamber onto the molded rubber floor mat at an angle of approximately 30-45 degrees to push water off of the surface of the molded rubber floor mat and promote quick drying. The dirty water in the interior washing chamber exits through a bottom drain which may be directed out to the surrounding environment, or into a containment tank or other device for disposal.

### BRIEF DESCRIPTION OF THE DRAWINGS

For a fuller understanding of the nature of the present invention, reference should be had to the following detailed description taken in connection with the accompanying drawings in which:

FIG. 1 is an isolated perspective view of the molded rubber floor mat washer of the present invention and showing a front of the washer with the front door open and revealing a portion of the interior washing chamber including a rotating pressure sprayer having an arrangement of arms and nozzles thereon, an arrangement of angled blower tubes, a floor drain and control buttons on the exterior top of the washer including a start button and a stop button and an indicator light;

FIG. 2 is a top perspective view of the interior washing chamber of the molded rubber floor mat washer shown with the front door open and holding a molded rubber floor mat in an open wire basket on the door, and an electromagnetic locking system for locking the door closed during operation;

FIG. 3 is a top, front perspective view of the interior washing chamber showing the molded rubber floor mat contained within the open wire basket on the front door, the arrangement of angled blower tubes, the rotating pressure sprayer and floor drain;

FIG. 4 is a perspective view of a rear compartment of the washer showing an arrangement of blower motors connected to hoses for delivering airflow to the angled blower tubes, as well as a motor and pump for delivering pressurized water or other fluid to the rotating pressure sprayer within the interior washing chamber;

FIG. 5 is a top perspective view of a typical molded rubber floor mat used in motor vehicles;

FIG. 6 is an isolated perspective view of a portion of the interior washing chamber and the front door in an open position, and illustrating an emergency shutoff switch;

FIG. 7 is a perspective view of the rotating pressure sprayer including the arrangement of arms extending from a central hub that is rotatably fitted to a central axle, and spray nozzles fitted to the distal ends of each of the arms;

FIG. 8A is a top plan view of a pressure spray nozzle that is fitted to an end of one of the arms of the rotating pressure sprayer; and

FIG. 8B is a side elevational view of the pressure spray nozzle of FIG. 8A.

Like reference numerals refer to like parts throughout the several views of the drawings.

### DETAILED DESCRIPTION OF THE PREFERRED EMBODIMENTS

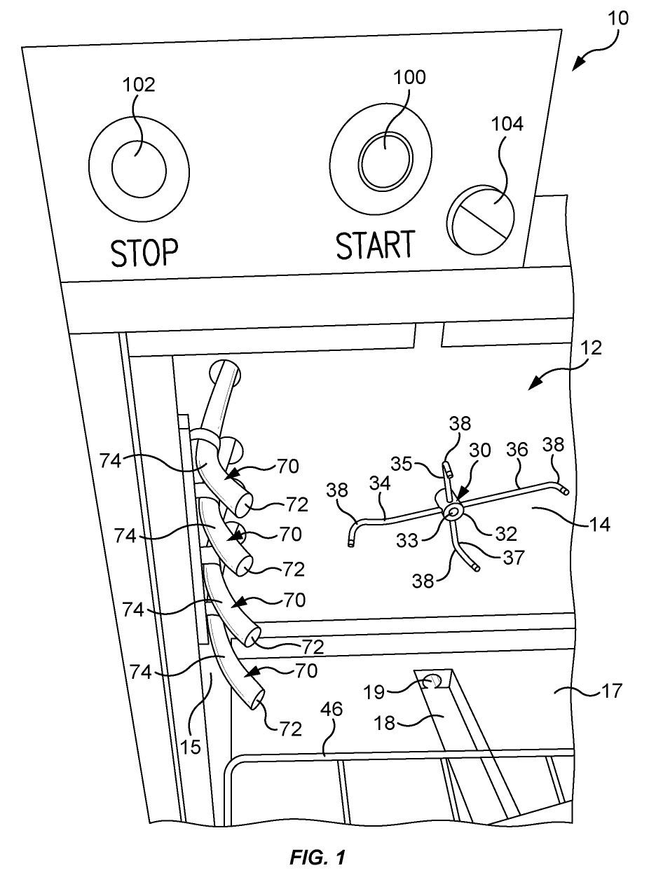

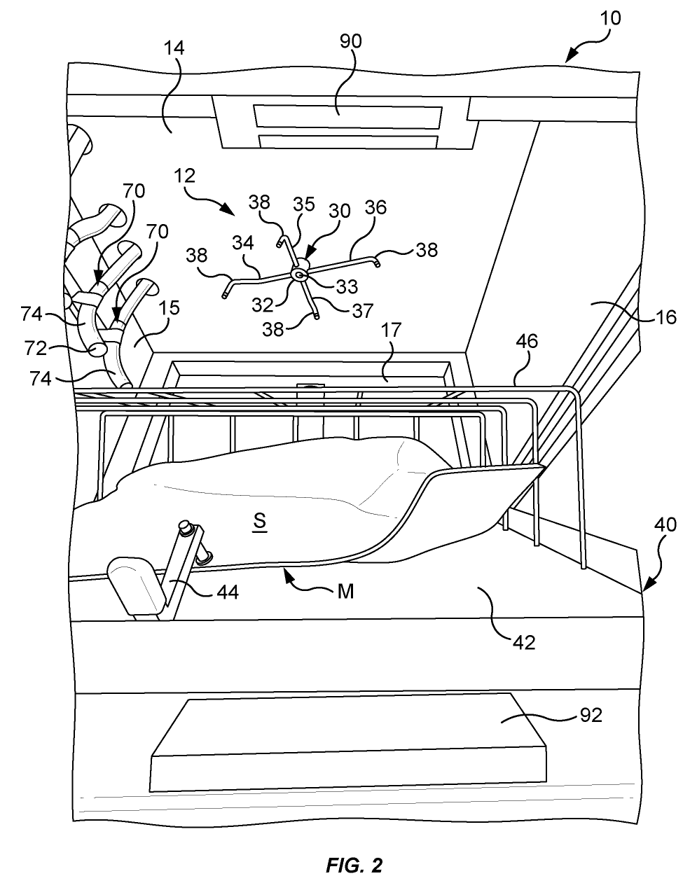

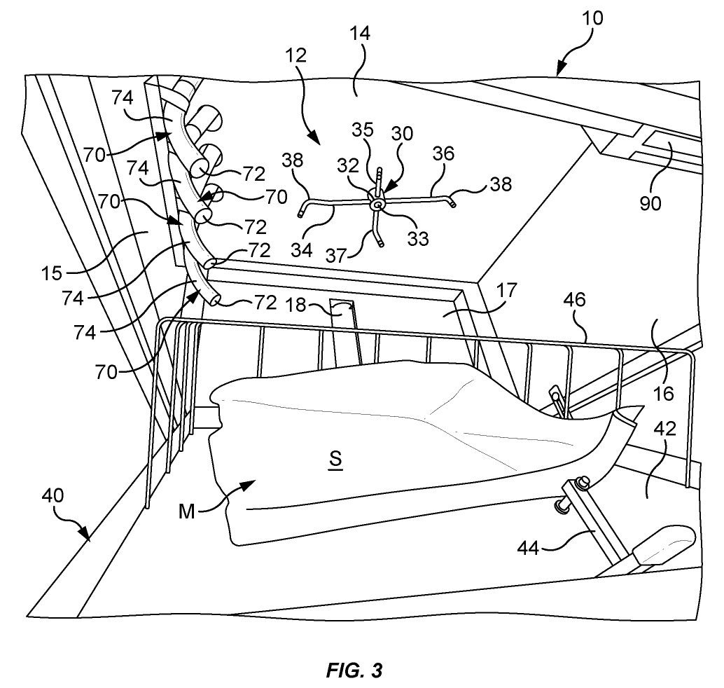

Referring to the several views of the drawings, and particularly FIGS. 1-4, the molded rubber floor mat washer machine of the present invention is shown and is generally indicated as 10.

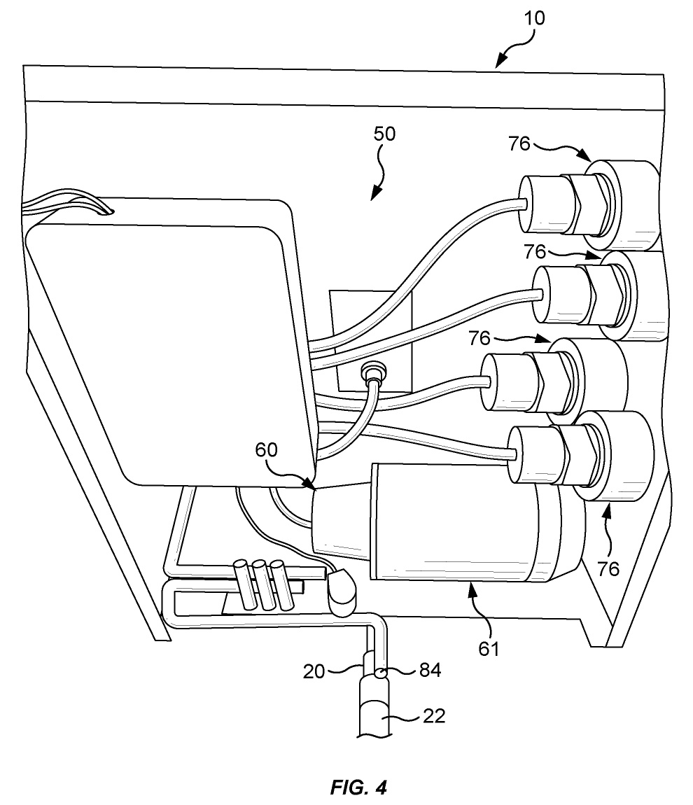

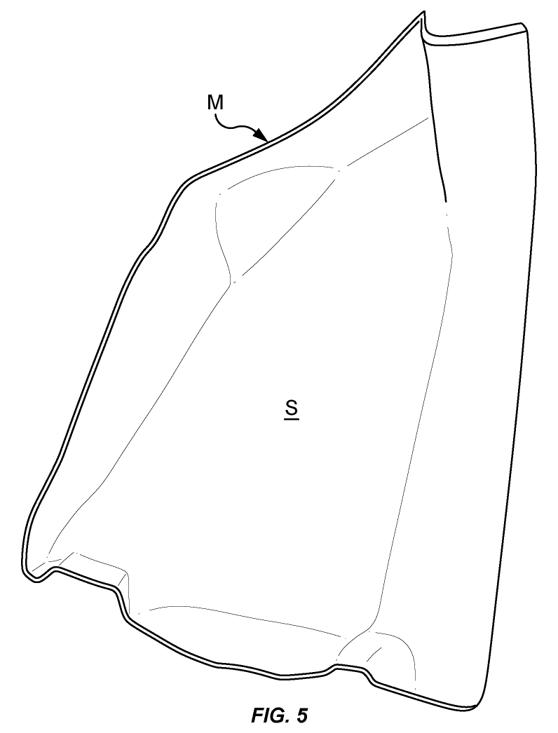

As seen in FIGS. 1-3, the molded rubber floor mat washer machine 10 includes an interior washing chamber 12 having a back wall 14, opposite side walls 15, 16 and a floor 17. A recessed trough 18 is centrally located in the floor 17 for draining fluid that is used during the washing process. More particularly, the floor 17 is sloped downwardly from the side walls 15, 16 and back wall 14 towards the central trough which extends from near the back wall 14 towards the front of the washing chamber 12. The bottom of the trough 18 is also sloped to allow the dirty water to drain out of the trough and through a passage 19 and to a discharge 20 on the back of the machine, as seen in FIG. 4. A hose 22 may be connected to the discharge 20 to allow the dirty water draining from the washing chamber to be directed to a ground drain system at a facility, such as a car wash facility. Alternatively, the dirty water may be directed to a collection reservoir for proper disposal.

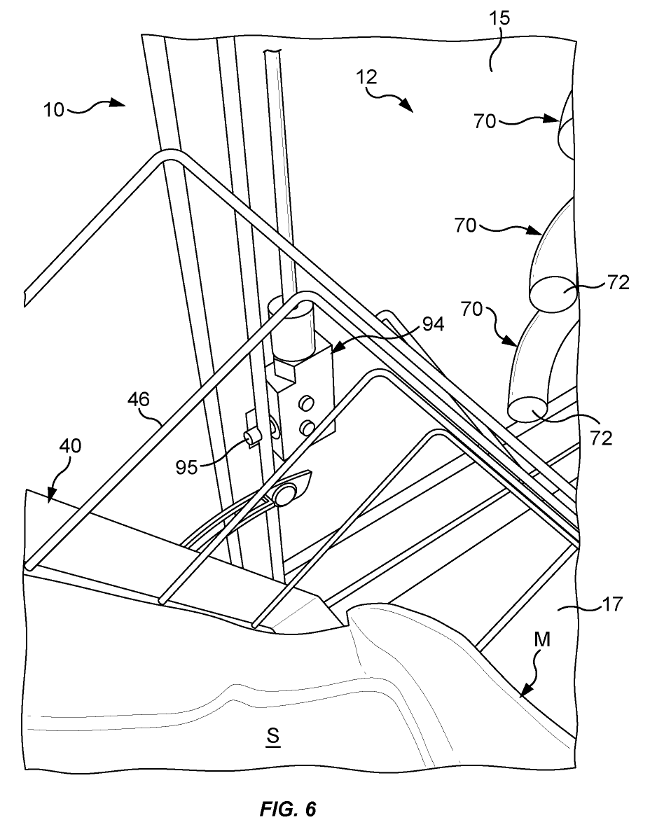

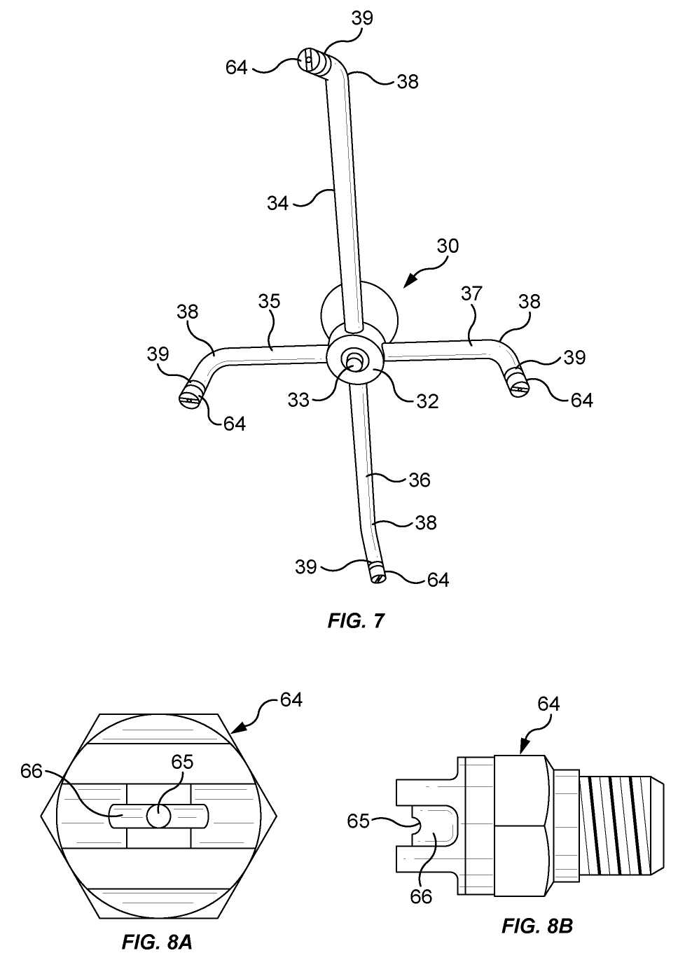

The interior washing chamber 12 includes a rotating pressure sprayer assembly 30 rotatably fitted to the back wall 14 of the washing chamber. More particularly, the rotating pressure sprayer assembly 30 includes a central hub 32 that rotates about a central axis 33. A pressurized supply of water is delivered to the central hub 32 from a rear of the washer (see FIG. 4). A number of arms 34, 35, 36 and 37 extend from the central hub 32 and bend at an elbow 38 towards the front of the washing chamber 12, and particularly towards an inside surface 42 of a front door 40 of the molded rubber floor mat washer machine 10. As seen in FIGS. 1-3, as well as FIG. 7, the arrangement of arms 34-37 extending from the central hub 32 include two longer arms 34, 36 in opposing relation to one another, and two shorter arms 35, 37 in opposing relation to one another. The arms 34-37 are hollow and receive the pressurized flow of water from a motor driven pump 60 in a rear chamber 50 of the mat washer machine 10, as described more fully hereinafter. A distal end 39 of each of the arms 34-37 on the rotating pressure sprayer assembly 30 is fitted with a pressure spray nozzle 64, as seen in FIGS. 7-8B. The pressure spray nozzle 64 on the distal end of one or more of the arms 34-37 of the rotating sprayer assembly 30 are structured to direct a pressurized release of water towards the inside surface 42 of the front door 40 when the door is closed and the mat washer machine 10 is in operation. More particularly, the spray nozzles 64 are structured to deliver a pressurized spray of water in a fanned array towards the inside surface 42 of the front door 40, and particularly onto the molded rubber floor mat M that is either clipped to the inside surface of the front door with a spring-loaded clip mechanism 44 or held within an open wire basket 46 on the inside 42 of the front door 40. The spray nozzles 64 are particularly structured and angled to direct the pressurized stream of water onto the entire exposed surfaces of the molded rubber floor mat M that is facing towards the rotating sprayer assembly 30 when the door 40 is closed and the mat washer machine 10 is in operation. At least one of the longer arms 34, 36 of the rotating pressure sprayer assembly 30 is offset at the elbow 38 and distal end 39 as best seen in FIG. 7. More particularly, the distal end of at least one of the longer arms 34, 36 is offset to one side, so that when a pressurized spray of liquid exits the spray nozzle 64 on that arm, the force of the spray propels rotation of the rotating sprayer assembly 30 about the central axis 33. As seen in FIGS. 8A and 8B, the pressure spray nozzles 64 have a discharge end 65 with a particularly configured nozzle opening 66 that directs the pressurized spray of water outwardly in the fanned array towards the molded rubber floor mat M that is held on the inside of the door 40. The pressure spray nozzles 64 may be fitted to the distal ends 39 of all four arms of the rotating pressure sprayer assembly 30 or, alternatively, to select ones of the arms to achieve the desired pressure and spray coverage during operation. Most importantly, the rotating sprayer assembly 30 must be able to direct the pressurized fanned array of water onto the entire surface S of the molded rubber floor mat M so the entire top surface S of the floor mat M is cleaned. More particularly, the pressurized water from the rotating sprayer assembly 30 must strike all areas of the top surface S to remove dirt, sand and other residue on the top of the floor mat M.

After the washing cycle, the rotating pressurized spray assembly 30 stops, the discharge of pressurized spray of water stops and a drying stage commences. More particularly, a forced flow of air is directed out from the open ends 72 of each of an arrangement of angled blower tubes 70 that are secured to the side wall 15 of the interior washing chamber 12, as seen in FIGS. 1-3. In this embodiment, there are four separate blower tubes 70 each connected to a separate blower motor 76 in the rear compartment 80 of the washer machine 10, as seen in FIG. 4. The end portions 74 of the blower tubes 70 are angled to point the open ends 72 in a direction that pushes the water off of the molded rubber floor mat M. More particularly, the water is pushed from one end of the molded rubber floor mat M that is closer to the blower tubes 70 toward the opposite end that has the raised lip. The angled high-pressure air flow pushes the water over the edges of the raised lips of the molded rubber floor mat M to completely dry the top surfaces of the mat. In a preferred embodiment, the end portions 74 of the blower tubes 70 are angled at an angle of between 30 and 50 degrees relative to the side wall. FIGS. 1-3 clearly illustrate the angle of the end portions 74 of the blower tubes relative to the side wall and the molded rubber floor mat M held on the inside 42 of the front door 40.

To operate the molded rubber floor mat washer 10, the user places the molded rubber floor mat M in the basket 46 on the inside of the door 40, with the door open. In addition, the user can secure the molded rubber floor mat M in place with the spring-loaded clip mechanism 44. Next, the door 40 of the washer machine is closed so that a strike plate 92 on the inside of the door 40, near the top, comes into abutting engagement with an electromagnetic lock mechanism 90 adjacent the top of the washing chamber 12, and facing outwardly. With the door 40 closed, the user can press the start button 100 which energizes the electromagnetic lock 90. The strike plate 92 is formed of a magnetically attractive material and a strong magnetic bond is created between the strike plate 92 and the electromagnetic locking mechanism 90, thereby preventing opening of the door 40 during operation of the washer 10. The molded rubber floor mat washer 10 then goes through the complete cycles of both washing, wherein the water is sprayed from the rotating sprayer assembly 30 onto the molded rubber floor mat M, and then a drying cycle, wherein the forced high-pressure flow of air is released from the blower tubes 70 and onto the mat M for completely drying the mat. At the end of the drying cycle, operation of the molded rubber floor mat washer 10 turns off, at which time the electromagnetic lock 90 is released to allow opening of the door 40 so that the user can retrieve the cleaned and dried molded rubber floor mat M. A light indicator 104 on the top of the machine, next to the start 100 and stop 102 control buttons indicates the status of the operation of the washer machine 10. This may include a green light and a red light, wherein the red light might indicate that the machine is currently in operation and that the door should not be opened.

In the event the front door 40 is inadvertently opened during operation of the washer machine 10, a spring-loaded safety switch 94 is actuated to interrupt power supply to the water pump motor 61 and the blower motors 76. As seen in FIG. 6, the safety switch 94 is mounted to the inside surface of the side wall 15 with the spring-loaded button 95 positioned to engage the inside surface 42 of the front door 40 when the door is closed. When the door 40 is closed, the spring-loaded button 95 of the safety switch 94 is pushed in to close the electric circuit that allows for operation of the high-pressure motorized water pump 60 and blowers 76. When the door 40 is opened, the spring-loaded button 95 of the safety switch 94 extends outwardly to open the circuit, thereby preventing operation of the high-pressure motorized pump 60 and blowers 76.

Referring to FIG. 4, the rear compartment 50 of the molded rubber floor mat washer 10 is shown. Within the rear compartment 50, the four blower motors 76 are mounted to one side wall and are connected to an electric power supply. Similarly, the high-pressure motor 61 and pump assembly 60 are contained within the rear compartment 50 and connected to an electric power supply. FIG. 4 further illustrates the quick disconnect 84 of the water supply to the high-pressure motorized pump 60 during operation of the machine. This can be achieved with the use of a conventional garden hose that delivers the flow of water to the pump 60.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A machine for washing and drying molded rubber floor mats, the machine comprising:
an interior washing chamber surrounded by a back wall, opposite side walls, a floor and a front door having an inside face;
an open basket mounted to the inside face of the front door, and the open basket structured and configured to receive and hold at least one molded rubber floor mat therein with a top surface of the molded rubber floor mat facing the rear wall when the door is closed;
a high-pressure motor-driven pump assembly structured and disposed to receive water from a water supply source and generate a pressurized flow of water;
a plurality of electrically powered blower motors each structured and disposed for generating a forced airflow;
a rotatable spray nozzle assembly positioned at a rear of the interior washing chamber adjacent to the rear wall, and the rotatable spray nozzle assembly fluidly connected to the high-pressure motor-driven pump assembly and structured and disposed to receive the pressurized flow of water and direct a pressurized sprayed array of the water towards the inside face of the front door when the front door is closed;
a plurality of blower tubes positioned within the washing chamber and each of the plurality of blower tubes connected to a respective one of the plurality of blower motors and structured and configured to receive the pressurized airflow and direct the pressurized airflow onto the molded rubber floor mat during a drying cycle; and
a control assembly structured and disposed to selectively and sequentially energize and active the high-pressure motor-driven pump assembly during a timed washing cycle and to energize and activate the plurality of blower motors to deliver the pressurized airflow to the plurality of blower tubes during the timed drying cycle.

2. The machine as recited in claim 1 wherein the plurality of blower tubes are each oriented at an angle of between 30 degrees and 50 degrees relative to one of the side walls in the interior washing chamber.

3. The machine as recited in claim 2 further comprising a spring-loaded clip mechanism on the inside face of the front door for securing the at least one molded rubber floor mat on the inside face of the front door with the top surface of the molded rubber floor mat facing the rear wall when the door is closed.

4. The machine as recited in claim 1 further comprising an electromagnetic lock mechanism including a strike plate mounted to the inside face of the front door and an electromagnet mounted to a top of the interior washing chamber, and the strike plate being structured and disposed for mating engagement with the electromagnet when the front door is closed, wherein the electromagnetic lock mechanism is energized during operation of the machine to prevent the door from opening during operation.

5. The machine as recited in claim 4 further comprising a safety switch structured and disposed to engage the front door when the door is in the closed position, and wherein the safety switch is configured to interrupt electric power supply to the motor-driven pump assembly and the plurality of electrically powered blower motors if the door is opened during operation of the machine.

6. The machine as recited in claim 1 further comprising a control panel including a start button, a stop button, and a status indicator light, wherein the status indicator light provides a visual signal of the current operation cycle of the machine.

7. The machine as recited in claim 1 wherein the motor-driven pump assembly further comprises a quick disconnect coupling structured and disposed to fluidly connect the motor-driven pump to a hose for delivery of the water supply.

8. The machine as recited in claim 1 further comprising a safety and locking system comprising:
an electromagnetic lock mechanism including a magnetically attractive strike plate and an electromagnet, and the electromagnetic lock mechanism structured and disposed to create a magnetic bond that prevents the front door from opening while the motor-driven pump and the plurality of electrically powered blower motors are energized; and
a spring-loaded safety switch configured to engage the inside face of the front door, wherein the safety switch automatically opens an electric circuit to interrupt power to the motor-driven pump and the plurality of electrically powered blower motors if the magnetic bond of the electromagnetic lock is broken by opening the front door during operation of the machine.

9. The machine as recited in claim 1 wherein the plurality of blower tubes are oriented at
an angle of between 30 degrees and 50 degrees relative to one of the side walls of the interior washing chamber, wherein the pressurized airflow is directed onto the top side of the molded rubber floor mat in a manner that forces water to flow to an end of the molded rubber floor mat and over raised lips of the molded rubber floor mat.
